(19) United States
(12) Patent Application Publication
(10) Pub. No.: US 2014/0300629 A1
(43) Pub. Date: Oct. 9, 2014

(54) ELECTRONIC DEVICE, HANDWRITTEN DOCUMENT PROCESSING METHOD, AND STORAGE MEDIUM

(71) Applicant: KABUSHIKI KAISHA TOSHIBA, Tokyo (JP)

(72) Inventor: Sachie Yokoyama, Ome-shi (JP)

(73) Assignee: KABUSHIKI KAISHA TOSHIBA, Tokyo (JP)

(21) Appl. No.: 14/068,388

(22) Filed: Oct. 31, 2013

(30) Foreign Application Priority Data
Apr. 9, 2013 (JP) 2013-081321

(51) Int. Cl. G09G 5/37

(52) U.S. Cl. CPC G09G 5/37
USPC 345/619

(57) ABSTRACT

According to one embodiment, an electronic device includes a display processor and a processor. The display processor is configured to display strokes handwritten on a screen. The processor is configured to divide strokes into a first stroke group corresponding to pre-defined objects and a second stroke group that does not correspond to pre-defined objects. The display processor is configured to display at least one object corresponding to the first stroke group and at least one line corresponding to the second stroke group on the screen after displaying the first stroke group and the second stroke group.

### CROSS-REFERENCE TO RELATED APPLICATIONS

This application is based upon and claims the benefit of priority from Japanese Patent Application No. 2013-081321, filed Apr. 9, 2013, the entire contents of which are incorporated herein by reference.

### FIELD

Embodiment described herein relate generally to shaping of a handwritten stroke.

### BACKGROUND

In recent years, various electronic devices such as tablets, PDA, and smartphones have been developed. Most of such kinds of electronic devices include a touch screen display to facilitate an input operation by the user.

The user can give instructions to the electronic device to execute a function related to a menu or object by touching the menu or object displayed on the touch screen display by a finger or the like. The user can also input a stroke of any shape by performing an input operation by handwriting on the screen using a pen. For example, the user can input a plurality of strokes in which a plurality of kinds of objects such as characters, tables, and figures is mixed by a handwritten input operation.

Some conventional electronic devices are provided with a recognition function to convert a stroke representing a handwritten character, table, figure or the like into respective object data. For example, a character stroke is converted into text data and a stroke representing a figure or table can be converted into figure/table data in which a distorted drawn line is shaped into a straight line. The electronic device can shape a handwritten input stroke by making a display based on object data after conversion.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an appearance of an electronic device according to an embodiment.

FIG. 2 is an exemplary diagram showing an example of a linked operation of a tablet computer and an external apparatus according to the embodiment.

FIG. 3 is an exemplary diagram illustrating the relation between strokes and time series information according to the embodiment.

FIG. 4 is an exemplary diagram illustrating the relation between strokes and time series information according to the embodiment.

FIG. 5 is a diagram showing an example of a system configuration of the tablet computer according to the embodiment.

FIG. 6 is a diagram showing an example of a note view screen according to the embodiment.

FIG. 7 is a diagram illustrating an example of a function configuration of a handwritten note application program according to the embodiment.

FIG. 8 is a block diagram showing an example of the relation between the handwritten note application program and an integrated application program according to the embodiment.

FIG. 9 is a diagram showing an example of a document structure of an XML file to manage a plurality of strokes in a handwritten page according to the embodiment.

FIG. 10 is a flow chart showing an example of the operation of the tablet computer according to the embodiment.

FIG. 11 is a flow chart showing an example of stroke group division processing according to the embodiment.

FIG. 12 is a diagram showing an example of a plurality of strokes to illustrate a concrete example of the stroke group division processing according to the embodiment.

FIG. 13 is a diagram showing an example of the plurality of strokes to illustrate the concrete example of the stroke group division processing according to the embodiment.

FIG. 14 is a diagram showing an example of the plurality of strokes to illustrate the concrete example of the stroke group division processing according to the embodiment.

FIG. 15 is a diagram showing an example of strokes classified as freehand objects according to the embodiment.

FIG. 16 is a diagram showing an example of the freehand objects into which two strokes are converted according to the embodiment.

FIG. 17 is a diagram showing an example of the document structure of an OOXML file containing two strokes according to the embodiment.

FIG. 18 is a diagram showing a display example of a stroke by the integrated application program according to the embodiment.

FIG. 19 is a diagram showing a display example obtained by shaping a stroke input by handwriting on the note view screen according to the embodiment.

### DETAILED DESCRIPTION

Various embodiments will be described hereinafter with reference to the accompanying drawings.

In general, according to one embodiment, an electronic device includes a display processor and a processor. The display processor is configured to display strokes handwritten on a screen. The processor is configured to divide strokes into a first stroke group corresponding to pre-defined objects and a second stroke group that does not correspond to pre-defined objects. The display processor is configured to display at least one object corresponding to the first stroke group and at least one line corresponding to the second stroke group on the screen after displaying the first stroke group and the second stroke group.

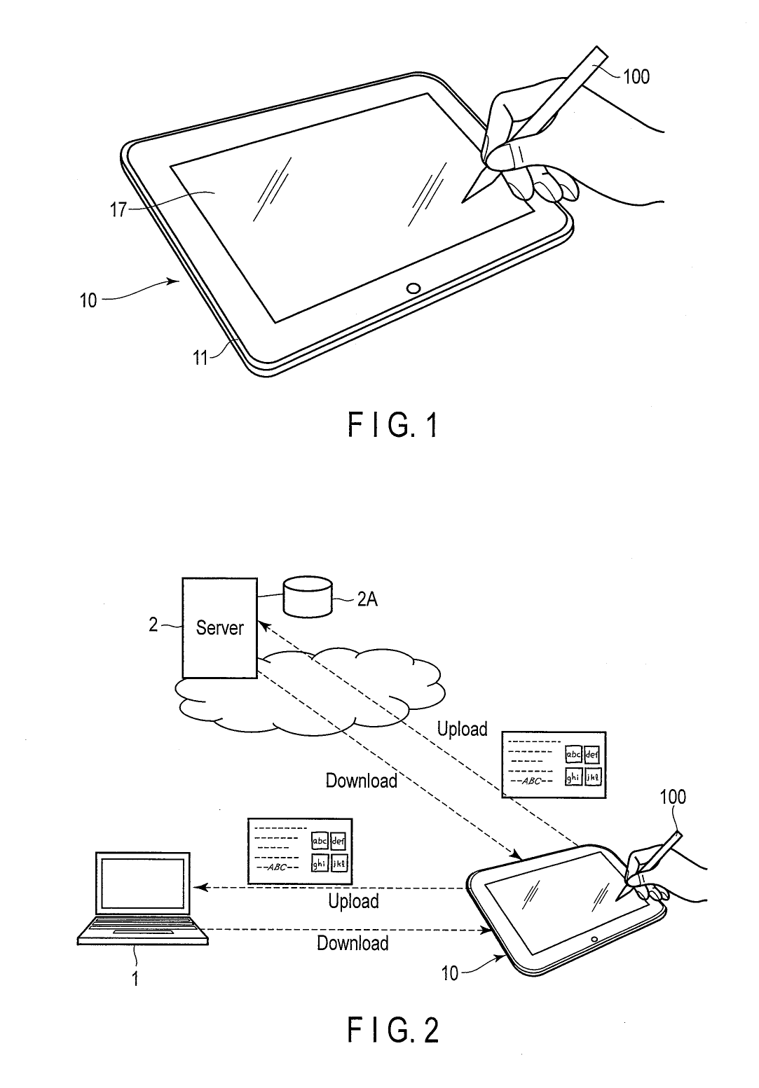

FIG. 1 is a perspective view showing an appearance of an electronic device according to an embodiment. The electronic device is, for example, pen-based mobile electronic device capable of handwritten input by a pen or finger. The electronic device is realized as a tablet computer, notebook personal computer, smartphone, PDA or the like. A case when the electronic device is realized as a tablet computer 10 will be assumed below. The tablet computer 10 is a mobile electronic device which is also called a tablet or slate computer and includes, as shown in FIG. 1, a main body 11 and a touch screen display 17. The touch screen display 17 is mounted by being laid on the main surface of the main body 11.

The main body 11 has a thin box cabinet. A flat panel display and a sensor configured to detect a contact position of a pen or finger on the screen of the flat panel display are incorporated in the touch screen display 17. The flat panel display may be, for example, a liquid crystal display (LCD). For example, an electrical capacitance touch panel or electromagnetic induction type digitizer can be used as a sensor. It is assumed below that two sensors of a digitizer and a touch panel are incorporated in the touch screen display 17 below.

The touch screen display 17 can detect not only a touch operation on the screen using a finger, but also a touch screen on the screen using a pen 100. The pen 100 may be, for example, an electromagnetic induction pen. The user can perform a handwritten input operation on the touch screen display 17 by using an external object (the pen 100 or a finger). A trajectory of movement of the external object (the pen 100 or a finger) on the screen, that is, a stroke (trajectory of a handwritten input) written by hand through a handwritten input operation is drawn in real time during handwritten input operation and a plurality of strokes input by handwriting is thereby displayed on the screen. A trajectory of movement of an external object while the external object is in touch with the screen corresponds to one stroke. A set of many strokes corresponding to handwritten characters and handwritten objects other than characters (handwritten figures, handwritten table and the like) constitutes a handwritten document.

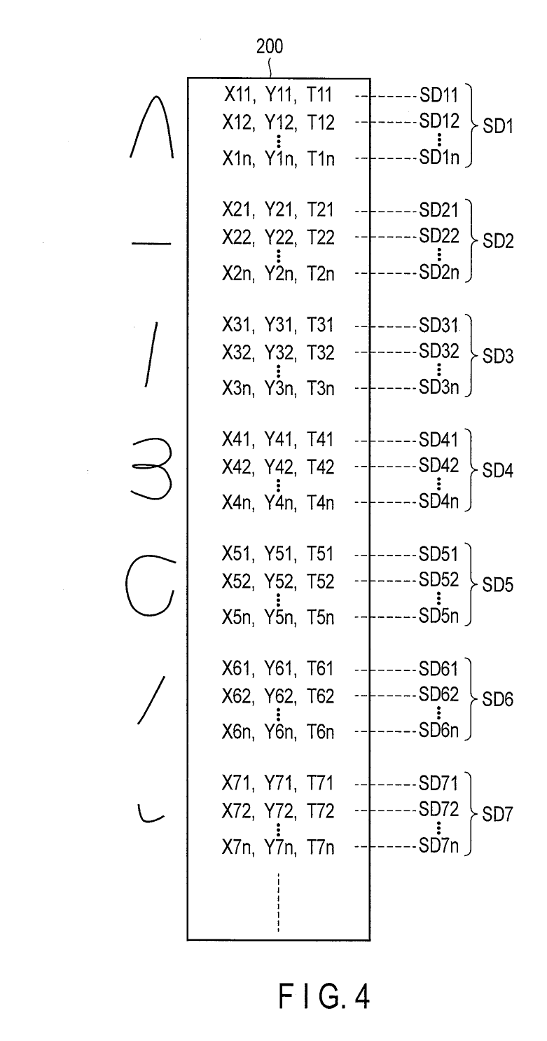

In the present embodiment, a handwritten document is stored, instead of image data, as time series information (handwritten document information) showing a coordinate string of a trajectory of each stroke and the order relation between the stroke in a storage medium. Examples of handwritten document information will be described later with reference to FIG. 4 and the handwritten document information shows the order in which a plurality of strokes is written by hand and also contains a plurality of pieces of stroke data corresponding to the plurality of respective strokes. In other words, handwritten document information means a set of stroke data of a time series corresponding to the plurality of respective strokes. Each piece of stroke data corresponds to some stroke and contains a plurality of pieces of coordinate data (time series coordinates) corresponding to each of a plurality of points on the trajectory of the stroke. The order of sequence of the stroke data corresponds to the order in which each stroke is written by hand.

The tablet computer 10 can read any existing handwritten document information from the storage medium and draw a trajectory of a plurality of strokes indicated by the handwritten document information on the screen. A plurality of strokes indicated by handwritten document information is the plurality of strokes input by handwriting.

Further, the tablet computer 10 has an editing function. The editing function can delete or move any portion (handwritten characters, handwritten marks, handwritten figures, handwritten tables and the like) in a handwritten document being displayed selected by a range selection tool according to an editing operation using an “eraser” tool, the range selection tool, and other various tools by user. Further, any portion in the handwritten document selected by the range selection tool can also be specified as a search key to search the handwritten document.

In the present embodiment, a handwritten document can be managed as one or a plurality of pages. In such a case, handwritten document information may be split into area units that can be contained in one screen to record a group of the handwritten document information that can be contained in one screen as a page. Alternatively, the page size may be made variable. In such a case, the page size can be widened to an area larger than the size of one screen and a handwritten document of an area larger than the screen size can be handled as a page. If the whole page cannot be displayed on the display at the same time, the page may be reduced or the display target portion in the page may be moved by vertical and horizontal scrolling.

FIG. 2 shows an example of a linked operation of the tablet computer 10 and an external apparatus. The tablet computer 10 can be linked to the personal computer 1 or a cloud. That is, the tablet computer 10 includes a wireless communication device such as a wireless LAN and can perform wireless communication with the personal computer 1. Further, the tablet computer 10 can perform communication with a server 2 on the Internet. The server 2 may be a server that executes an online storage service or other various cloud computing services.

The personal computer 1 includes a storage device such as a hard disk drive (HDD). The tablet computer 10 can transmit handwritten document information to the personal computer 1 over a network and record the information in the HDD of the personal computer 1 (upload). To ensure secure communication between the tablet computer 10 and the personal computer 1, the personal computer 1 may authenticate the tablet computer 10 when communication is started. In such a case, a dialog to prompt the user to input the ID or password may be displayed on the screen of the tablet computer 10 or the ID of the tablet computer 10 or the like may automatically be transmitted from the tablet computer 10 to the personal computer 1.

Accordingly, even if the capacity of storage of the tablet computer 10 is small, the tablet computer 10 can handle many pieces of handwritten document information or large-capacity handwritten document information.

Further, the tablet computer 10 can read any at least one piece of handwritten document information recorded in the HDD of the personal computer 1 (download) and display strokes indicated by the handwritten document information on the screen of the display 17 of the tablet computer 10. In such a case, a list of thumbnails obtained by reducing each page of a plurality of pieces of handwritten document information may be displayed on the screen of the display 17 or one page selected from these thumbnails may be displayed on the screen of the display 17 in the normal size.

Further, the partner of communication of the tablet computer 10 may be, instead of the personal computer 1, the server 2 on the cloud that provides a storage service or the like. The tablet computer 10 can transmit handwritten document information to the server 2 via a network and record the information in a storage device 2A of the server 2 by transmitting the information (upload). Further, the tablet computer 10 can read any handwritten document information recorded in the storage device 2A of the server 2 (download) and display the trajectory of each stroke indicated by the handwritten document information on the screen of the display 17 of the tablet computer 10.

In the present embodiment, therefore, the storage medium where handwritten document information is stored may be any of the storage device inside the tablet computer 10, the storage device inside the personal computer 1, and the storage device of the server 2.

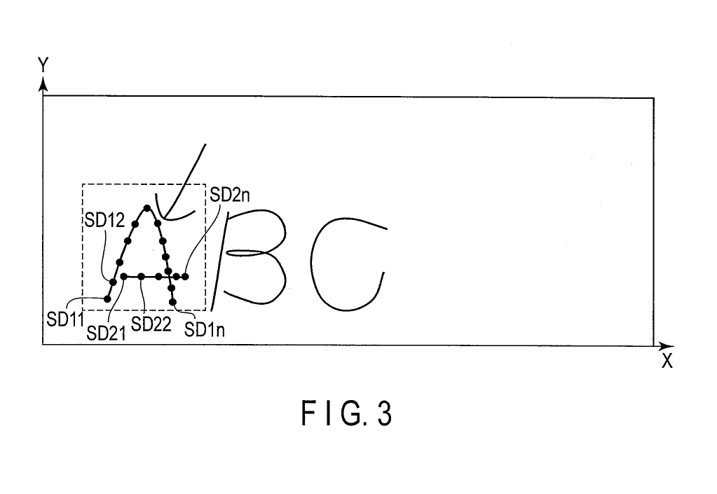

Next, the relationship between a stroke (such as a character, mark, figure, or table) written by hand by the user and time series information will be described with reference to FIGS. 3 and 4. FIG. 3 shows an example of the handwritten document (handwritten character string) written by hand on the touch screen display 17 by using the pen 100 or the like.

The handwritten document shown in FIG. 3 shows an example in which a handwritten character string “ABC” is written by hand in the order of “A”, “B”, and “C” and then a handwritten arrow is input close to the handwritten character “A”.

The handwritten character “A” is represented by two strokes (a first stroke and a second stroke) written by hand using the pen 100 or the like. The first stroke first written by hand is represented by time series coordinates SD11, SD12, . . . , SD1n (stroke data) detected by, for example, sampling a trajectory of the pen 100 at regular time intervals. Similarly, the second stroke is represented by time series coordinates SD21, SD22, . . . , SD2n (stroke data). Incidentally, the number of pieces of coordinate data representing one stroke may be different from stroke data to stroke data.

The handwritten character “B” is represented by two strokes written by hand using the pen 100 or the like, that is, two trajectories. The handwritten character “C” is represented by one stroke written by hand using the pen 100 or the like, that is, one trajectory. The handwritten “arrow” is represented by two strokes written by hand using the pen 100 or the like, that is, two trajectories.

FIG. 4 shows time series information 200 corresponding to the handwritten document in FIG. 3. The times series information contains a plurality of pieces of stroke data SD1, SD2, . . . , SD7. In the time series information 200, the stroke data SD1, SD2, . . . , SD7 are arranged in time series in the order of handwriting, that is, the order in which a plurality of strokes is written by hand.

In the time series information 200, the first two pieces of stroke data SD1, SD2 indicate two strokes of the handwritten character “A”. The third and fourth pieces of stroke data SD3, SD4 indicate two strokes constituting the handwritten character “B”. The fifth piece of stroke data SD5 indicates one stroke constituting the handwritten character “C”. The sixth and seventh pieces of stroke data SD6, SD7 indicate two strokes constituting the handwritten “arrow”.

Each piece of stroke data contains a coordinate data series (times series coordinates) corresponding to one stroke, that is, a plurality of coordinates corresponding to each of a plurality of points on a trajectory of one stroke. In each piece of stroke data, the coordinates are arranged in time series in the order in which the stroke is written.

Each piece of coordinate data indicates an X coordinate and a Y coordinate corresponding to one point present in the corresponding trajectory. For example, coordinate data SD11 shows the X coordinate (X11) and the Y coordinate (Y11) of the start point of the first stroke of the handwritten character “A” and SD1n shows the X coordinate (X1n) and the Y coordinate (Yin) of the end point of the first stroke.

Further, each piece of coordinate data may contain time stamp information T corresponding to a point in time when the point corresponding to the coordinates is written by hand. The point in time of handwriting may be an absolute time (for example, year, month, day, hour, minute, second) or a relative time relative to some point in time as a reference. For example, the absolute time (for example, year, month, day, hour, minute, second) when a stroke is started to be written may be added to each piece of stroke data as time stamp information and further, a relative time indicating a difference from the absolute time may be added to each piece of coordinate data in the stroke data as time stamp information T.

Thus, by using time series information in which the time stamp information T is added to each piece of coordinate data, the temporal relationship between strokes can be represented more precisely.

Further, information (Z) indicating a handwriting pressure may be added to each piece of coordinate data.

The time series information 200 having a structure as described with reference to FIG. 4 can represent not only handwriting of individual strokes, but also the temporal relationship between strokes.

Therefore, by using the time series information 200, even if, as shown in FIG. 3, the tip portion of the handwritten “arrow” is written by being overlaid on the handwritten character “A” or close to the handwritten character “A”, the handwritten character “A” and the tip portion of the handwritten “arrow” can be handled as different characters or figures.

For example, by analyzing the time series information 200 contained in the rectangular frame of the broken line shown in FIG. 3, two strokes (stroke data SD1, SD2) of the handwritten character “A” can be determined to have been written by hand successively and further, the tip portion (stroke data SD7) of the handwritten “arrow” and the handwritten character “A” can be determined to be discontinuous in timing. Therefore, the handwritten character “A” in the rectangular frame of the broken line and the tip portion (stroke data SD7) of the handwritten “arrow” can be handled as different characters or figures.

Whether handwriting timing of the tip portion (stroke data SD7) of the handwritten “arrow” and handwriting timing of the handwritten character “A” are discontinuous can be determined based on the sequence of stroke data in the time series information. Alternatively, the determination may be made by using the above time stamp information T. By using the time stamp information T, a more precise determination can be made.

The above determination may be made based on both of the sequence of stroke data in the time series information and the above time stamp information T. For example, if a predetermined number of pieces of stroke data or more are contained between the stroke data SD2 and the stroke data SD7, writing timing of the stroke data SD7 and writing timing of the stroke data SD2 may be determined to be discontinuous. If the number of pieces of stroke data between the stroke data SD2 and the stroke data SD7 is less than the predetermined number, whether writing timing of the stroke data SD7 and writing timing of the stroke data SD2 are discontinuous may be determined based on time stamp information inside the stroke data SD2 and time stamp information inside the stroke data SD7. In such a case, time stamp information T2n added to the last coordinate data inside the stroke data SD2 and time stamp information T71 added to the first coordinate data inside the stroke data SD7 may be compared.

Further, in the time series information 200 in the present embodiment, as described above, the sequence of stroke data SD1, SD2, . . . , SD7 shows the order of writing handwritten characters. For example, the sequence of the stroke data SD1, SD2 shows that the first stroke of the handwritten character “A” is written by hand and then the second stroke thereof is written by hand. Therefore, even if two handwritten characters resemble each other in handwriting, the two handwritten characters can be distinguished as different characters if the two handwritten characters have mutually different orders of handwriting.

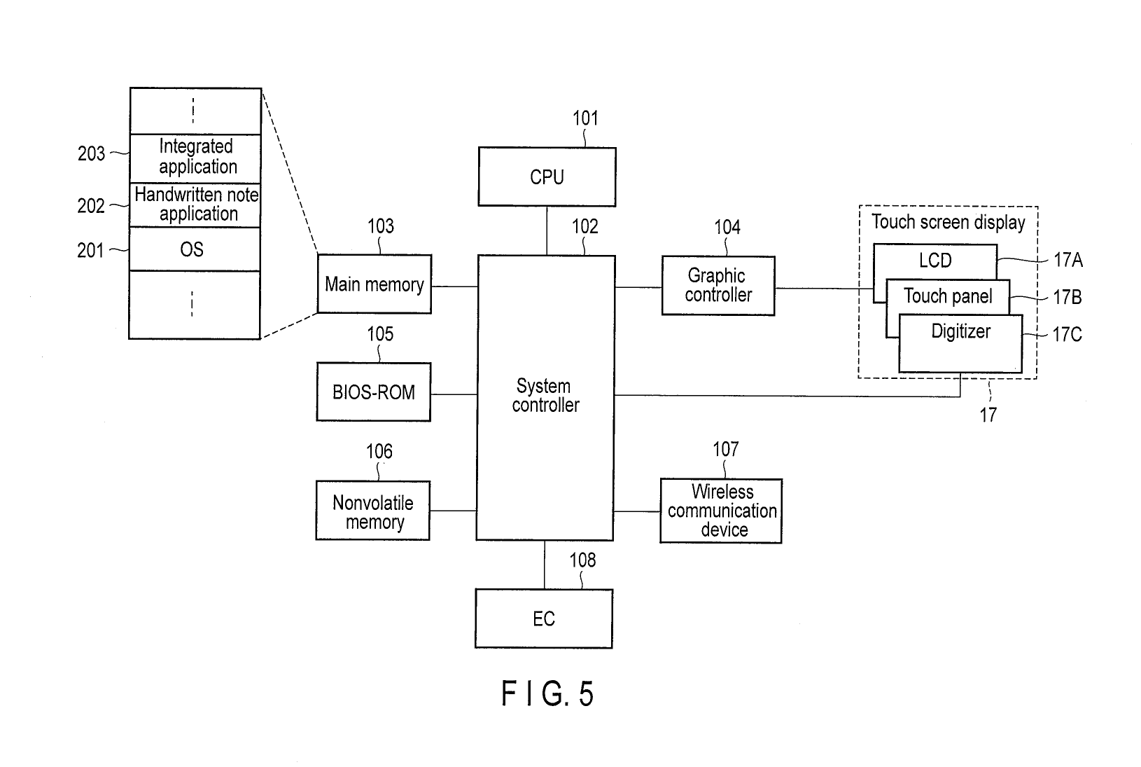

FIG. 5 is a diagram showing the system configuration of the tablet computer 10.

The tablet computer 10 includes, as shown in FIG. 5, a CPU 101, a system controller 102, a main memory 103, a graphic controller 104, a BIOS-ROM 105, a nonvolatile memory 106, a wireless communication device 107, and an embedded controller (EC) 108.

The CPU 101 is a processor that controls operations of various modules in the tablet computer 10. The CPU 101 executes various kinds of software loaded from the nonvolatile memory 106 as a storage device into the main memory 103. Such software includes an operating system (OS) 201 and various application programs. Application programs include a handwritten note application program 202 and an integrated application program 203. The handwritten note application program 202 has a function to create and display the above handwritten document information, a function to edit the handwritten document information, a handwritten document search function to search for handwritten document information containing a desired handwritten portion or a desired handwritten portion in handwritten document information, and a stroke shaping function to shape a stroke in a handwritten document. The stroke shaping function divides strokes input by handwriting into object types such as characters, figures, and tables and performs recognition processing and shaping processing on each object type to convert each object type into data (object data) that can be used by other applications such as the integrated application program 203. The integrated application program 203 has a function to process object data of characters, figures, tables and the like.

Also, the CPU 101 executes a basic input/output system (BIOS) stored in the BIOS-ROM 105. The BIOS is a program to control hardware.

The system controller 102 is a device connecting a local bus of the CPU 101 and various components. The system controller 102 also contains a memory controller that controls access to the main memory 103. The system controller 102 also has a function to perform communication with the graphic controller 104 via a serial bus in the PCI EXPRESS standard or the like.

The graphic controller 104 is a display controller that controls an LCD 17A used as a display monitor of the tablet computer 10. A display signal generated by the graphic controller 104 is sent to the LCD 17A. The LCD 17A displays a screen image based on the display signal. On the LCD 17A, a touch panel 17B and a digitizer 17C are arranged. The touch panel 17B is an electrostatic capacitance pointing device to input on the screen of the LCD 17A. The contact position on the screen where a finger comes into contact and movement of the contact position are detected by the touch panel 17B. The digitizer 17C is an electromagnetic induction type pointing device to input on the screen of the LCD 17A. The contact position on the screen where the pen 100 comes into contact and movement of the contact position are detected by the digitizer 17C.

The wireless communication device 107 is a device configured to perform wireless communication such as wireless LAN, 3G mobile communication or the like. The EC 108 is a one-chip microcomputer containing an embedded controller for power management. The EC 108 has a function to turnon or turn off the tablet computer 10 according to an operation of a power button (not shown) by the user.

Next, an example of the screen to accept a handwritten input operation presented by the handwritten note application program 202 will be described.

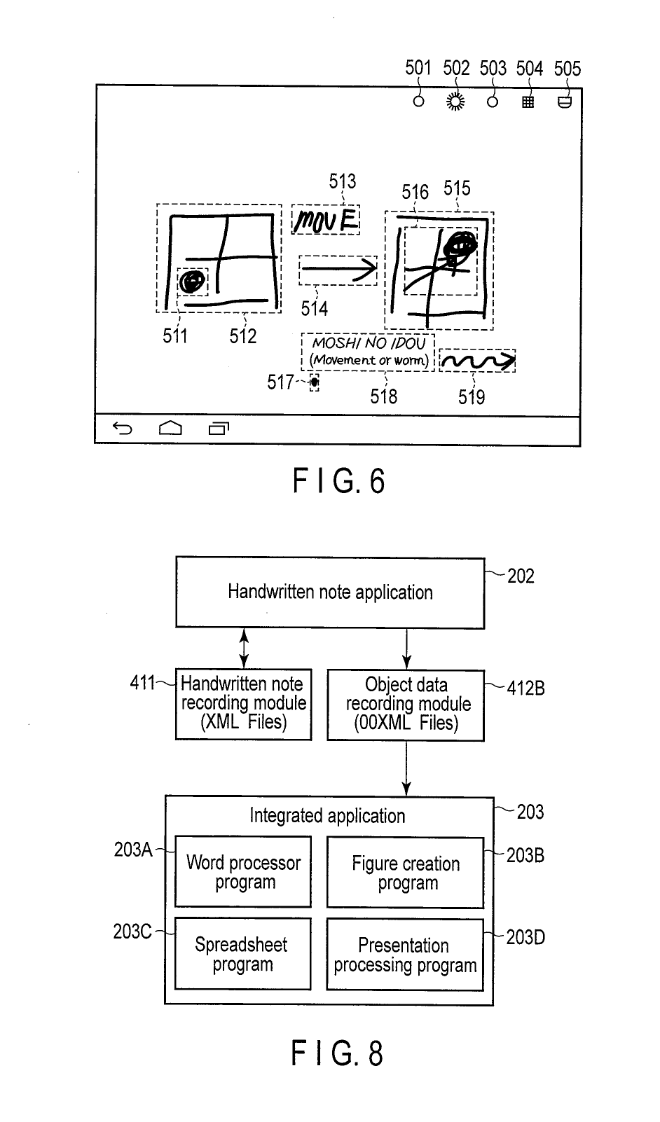

FIG. 6 shows an example of the note view screen capable of newly creating a page (handwritten page) and browsing and editing existing pages.

A black pen button 501, a red pen button 502, a marker button 503, a selection button 504, and an eraser button 505 are displayed on the note view screen.

If, for example, a handwritten input operation using the pen 100 is performed on the note view screen while the black pen button 501 is selected by a tap gesture of the user, the handwritten note application program 202 displays a black stroke (trajectory) on the note view screen fitting to movement of the pen 100.

If a handwritten input operation using the pen 100 is performed on the note view screen while the eraser button 505 is selected by a tap gesture of the user, the handwritten note application program 202 erases a stroke (trajectory) within a predetermined range relative to the position where the pen 100 passes fitting to movement of the pen 100.

The note view screen shown in FIG. 6 shows a state in which a plurality of strokes is input by handwriting. For example, a plurality of strokes 513, 518 representing characters, a plurality of strokes 511, 514, 516, 519 representing figures, a plurality of strokes 512, 515 representing tables, and a stroke 517 input unintentionally by the user are contained.

In addition, a plurality of button icons corresponding to the functions that can be executed on the note view screen is displayed on the note view screen (not shown). The plurality of button icons includes, for example, buttons corresponding to each function such as the input mode switching (the handwritten input mode, text input mode), page feed, page insertion, handwritten document search, and stroke shaping. When a tap operation on the shaping button corresponding to stroke shaping is performed by the user, the electronic device shapes by a stroke shaping function a plurality of strokes input by handwriting on the note view screen and displays the shaped strokes.

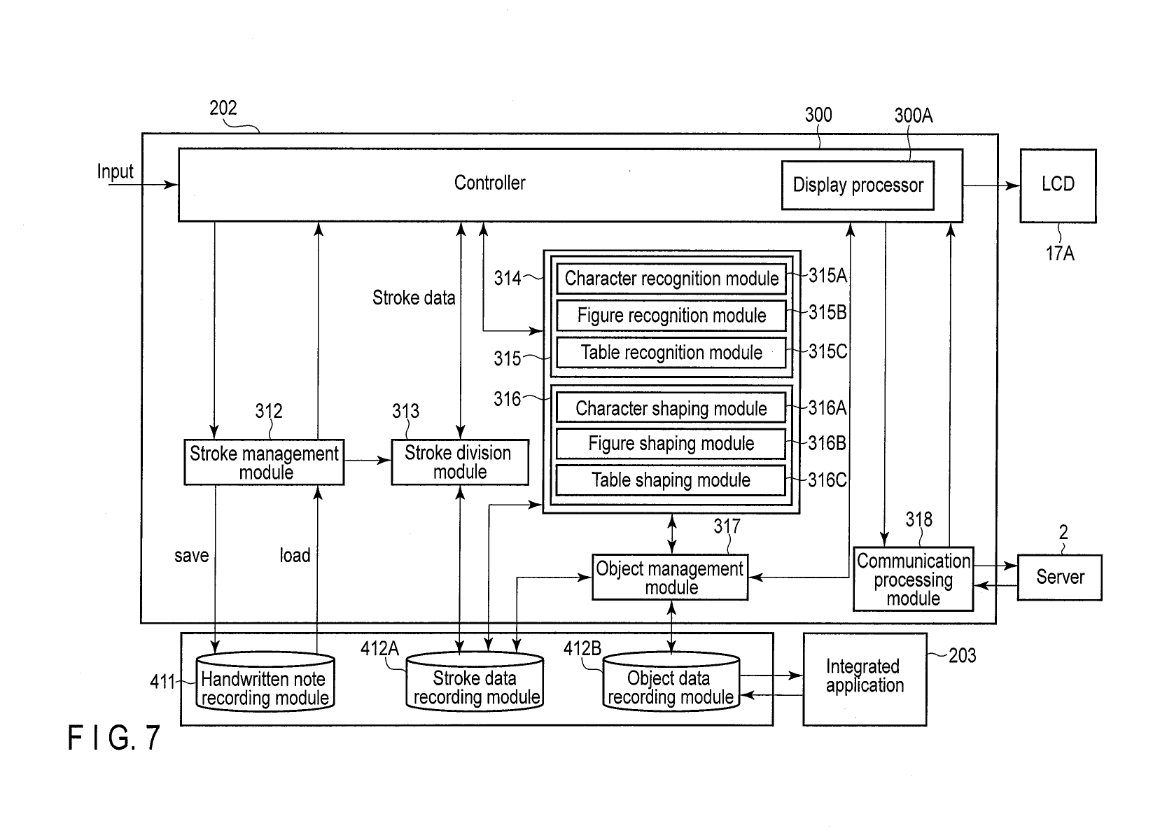

Next, the function configuration of the handwritten note application program 202 will be described with reference to FIG. 7.

The handwritten note application program 202 is a WYSIWYG application capable of handling handwritten document information and includes a controller 300 (display processor 300A), a stroke management module 312, a stroke division module 313, a shaping processor 314 (a recognition module 315, a shaping module 316), an object management module 317, and a communication processor 318.

The handwritten note application program 202 records various kinds of data to be processed including handwritten document information (a plurality of pieces of stroke data) in a recording module 410 and reads out such data when necessary. The recording module 410 can be realized by the nonvolatile memory 106 provided in the tablet computer 10. Incidentally, the recording module 410 can also be realized by the storage device (HDD) of the personal computer 1 or the storage device 2A of the server 2.

The recording module 410 includes a handwritten note recording module 411, a stroke data recording module 412A, and an object data recording module 412B. The handwritten note recording module 411 records data of handwritten document information (a plurality of strokes) input by handwriting on the note view screen. The stroke data recording module 412A records a plurality of strokes input by handwriting on the note view screen by dividing the strokes into a first stroke group corresponding to preset objects (for example, characters, figures, and tables) and a second stroke group that does not correspond to such objects. The object data recording module 412B records object data generated by converting data of strokes contained in the first stroke group and the second stroke group into a preset data format.

In the present embodiment, handwritten document information (a plurality of pieces of stroke data) recorded in the handwritten note recording module 411 is managed in a file format corresponding to, for example, a markup language. As the file format corresponding to a markup language, for example, an XML (Extensible Markup Language) file can be used. In this case, a plurality of pieces of stroke data in handwritten document information is stored in an XML file in a format of the hierarchical document structure described in the markup language. For example, one handwritten page may be managed by one XML file. In this case, as many XML files as the number of handwritten pages are created. Alternatively, a plurality of handwritten pages may be managed by one XML file.

Object data recorded in the object data recording module 412B is managed in a file format corresponding to, for example, a markup language. As the file format corresponding to a markup language, for example, an OOXML (Office Open Extensible Markup Language) file can be used. An OOXML file has a data format (file format) that can be processed by other applications, for example, the integrated application program 203. One handwritten page may be managed by one OOXML file or a plurality of handwritten pages may be managed by one OOXML file.

The function of each module in the handwritten note application program 202 will be described below.

The controller 300 has the display processor 300A. The display processor 300A receives a coordinate data sequence corresponding to a trajectory (stroke) of movement of the pen 100 from the touch screen display 17 (for example, the digitizer 17C). The display processor 300A displays a plurality of strokes input by handwriting on the screen of the LCD 17A based on the coordinate data sequence. For example, while the note view screen shown in FIG. 6 is displayed, the display processor 300A draws strokes on the note view screen based on an input coordinate sequence from the digitizer 17C. In addition, the controller 300 transmits, for example, in units of stroke a coordinate data sequence (stroke data) corresponding to a plurality of points on the stroke to the stroke management module 312.

The stroke management module 312 records a plurality of pieces of stroke data corresponding to a plurality of strokes contained in a handwritten document (handwritten page) in the handwritten note recording module 411. More specifically, the stroke management module 312 generates time series information having a structure as described in detail with reference to FIG. 4 based on a coordinate data sequence input from the digitizer 17C and records the time series information in the handwritten note recording module 411 as stroke data of a handwritten page. Further, the stroke management module 312 reads stroke data of any handwritten page from the handwritten note recording module 411. The stroke data corresponding to the read page is transmitted to the display processor 300A. The display processor 300A analyzes time series information and displays each stroke (each stroke input by handwriting) indicating by the time series information on the screen of the LCD 17A based on the analysis result. The stroke management module 312 in the embodiment records a plurality of pieces of stroke data corresponding to a plurality of strokes written by hand in a handwritten page (note view screen) in the handwritten note recording module 411 in the data format of an XML file.

The stroke division module 313 performs stroke group division processing to divide strokes contained in a handwritten page (note view screen) into a first stroke group corresponding to preset objects and a second stroke group that does not correspond to such objects based on stroke data recorded in the handwritten note recording module 411 and records the first stroke group and the second stroke group in the stroke data recording module 412A.

First, the stroke division module 313 divides a plurality of strokes into stroke groups containing at least one stroke based on, for example, the arrangement relation of the strokes indicated by stroke data. Further, the stroke division module 313 determines to which object each stroke group corresponds based on data defining a detailed, classification of objects, wherein the data is prepared for each types of object. The stroke division module 313 classifies the stroke group into the first stroke group which corresponds to one of the objects and the second stroke group that does not correspond to such objects.

The detailed classification of objects include data indicating, for example, stroke features for each language (English, Japanese and so on) regarding a character string, stroke features of various figure patterns such as the circle, square, arrow, straight line and so on regarding a figure, and combination features of a plurality of linear strokes constituting a table regarding a table. Data to classify stroke groups may contain other data than the above data.

For example, a stroke group representing a character string frequently has a higher density of strokes than a handwritten figure or handwritten table and is arranged in the horizontal direction or vertical direction within a fixed width. A stroke group representing a figure has a lower density of strokes than a character string and features of some figure pattern. A stroke group representing a table has linear strokes arranged in the vertical direction or horizontal direction and an end of a stroke is close to an end of another stroke.

The stroke division module 313 classifies each stroke group contained in the first stroke group into a corresponding object (the character object, figure object, and table object) and classifies a stroke group corresponding to none of the objects as the second stroke group.

The shaping processor 314 performs processing to shape each stroke classified into the first stroke group by the stroke division module 313 by fitting to the type of the object. The shaping processor 314 includes the recognition module 315 and the shaping module 316.

The recognition module 315 includes a character recognition module 315A, a figure recognition module 315B, and a table recognition module 315C.

The character recognition module 315A recognizes stroke groups determined by the stroke division module 313 to correspond to character objects as characters and converts handwritten characters represented by the stroke group into respective character code.

The figure recognition module 315B performs figure recognition processing to convert a stroke group determined by the stroke division module 313 to correspond to a figure object into one of a plurality of preset figure objects (such as a circle, square, arrow and the like). The figure recognition module 315B holds figure information showing features of each of a plurality of figure objects in advance and calculates a similarity between the handwritten figure and each of the plurality of figure objects. The figure recognition module 315B selects the figure object having the highest similarity as the recognition result for the stroke group. In the calculation of the similarity, trajectory information of strokes of the handwritten figure and trajectory information of each figure object are each handled as a set of vectors and the similarity can be calculated by comparing the sets of vectors.

In the calculation of the similarity, the handwritten figure (stroke group) may be rotated, enlarged, or reduced if necessary and the similarity between the handwritten figure after being rotated, enlarged, or reduced and each of the plurality of figure objects is calculated. The figure recognition module 315B selects the figure object having the highest similarity to the handwritten figure as the recognition result and adds attribute information showing processing content of the rotation, enlargement, or reduction. Strokes representing the handwritten figure can be displayed after being converting into a shaped figure by rotating, enlarging, or reducing the figure object according to attribute information.

The table recognition module 315C decides the numbers of rows and columns and the size of each cell defining the shape of the table of a stroke group determined by the stroke division module 313 to correspond to a table object based on a combination of linear strokes in the vertical and horizontal directions.

If, as a result of performing recognition processing by the recognition module 315, a stroke group classified into the first stroke group by the stroke division module 313 is determined to correspond to none of objects, the stroke group is classified into the second stroke group. That is, erroneous recognition is more likely to occur if a stroke input by handwriting is recognized by forcibly classifying the stroke into one of the objects. Therefore, the handwritten note application program 202 in the present embodiment is allowed to output a stroke that cannot be reliably recognized as one of the objects unchanged as a handwritten stroke without shaping.

The shaping module 316 includes a character shaping module 316A, a figure shaping module 316B, and a table shaping module 316C.

The character shaping module 316A decides data that defines the character size and display position so that the character recognized by the character recognition module 315A is displayed in the position of strokes representing the character input by handwriting in the page.

The figure shaping module 316B decides data that defines the figure size and display position so that the figure recognized by the figure recognition module 315B is displayed in the position of strokes representing the figure input by handwriting in the page.

The table shaping module 3160 decides data that defines the table size and display position so that the table recognized by the table recognition module 315C is displayed in the position of strokes representing the table input by handwriting in the page.

The object management module 317 manages objects (characters, figures, and tables) corresponding to the first stroke group and shaped by the shaping processor 314 and data of the second stroke group. The object management module 317 has a function to convert first stroke data representing each stroke contained in the first stroke group into first data representing an object in a preset data format and to convert second stroke data representing each stroke contained in the second stroke group into second data in a data format. It is assumed here that the preset data format is a data format managed as an OOXML file. The object management module 317 converts the second stroke data of the second stroke group into data that can be managed by an OOXML file and defines an undefined stroke, instead of data of a preset specific object. Hereinafter, an undefined stroke is called a freehand object and data indicating a freehand object is called freehand object data. The object management module 317 records objects converted into a data format managed as an OOXML file and corresponding to strokes input by handwriting and data (object data) representing the second stroke group (freehand object) in the object data recording module 412B.

Object data recorded in the object data recording module 412B can be processed by the integrated application program 203.

The communication processor 318 controls communication with the server 2 under the control of the controller 300. The communication processor 318 functions as a transmitting module that transmits (upload), for example, handwritten page data to the server 2 and also as a receiving module that receives any piece of handwritten page data recorded in the server 2 from the server 2. By providing the functions of the stroke division module 313, the shaping processor 314, and the object management module 317 on the server 2, the controller 300 can cause the server 2 to perform the above processing and receive the processing result through the communication processor 318.

FIG. 8 is a block diagram showing the relation between the handwritten note application program 202 and the integrated application program 203.

When strokes are written by hand on the touch screen display 17 using the pen 100, as described above, the handwritten note application program 202 causes the LCD 17A to display the strokes input by handwriting and also records stroke data indicating the strokes in the handwritten note recording module 411 as an XML file. In addition, the handwritten note application program 202 performs shaping processing on strokes input by handwriting to divide the strokes into the first stroke group corresponding to one of objects and the second stroke group that corresponds to none of the objects, converts into data formats that are managed by respective OOXML files, and records the converted data in the object data recording module 412B.

The integrated application program 203 includes a program that processes data managed by an OOXML file. The integrated application program 203 includes, for example, a word processor program 203A to edit document creation, a figure creation program 203B to edit figure creation, a spreadsheet program 203C to perform spreadsheet processing, and a presentation processing program 203D to create data for presentation including objects such as documents, figures, and tables. Each program can process data of various objects such as characters, figures, and tables managed by an OOXML file.

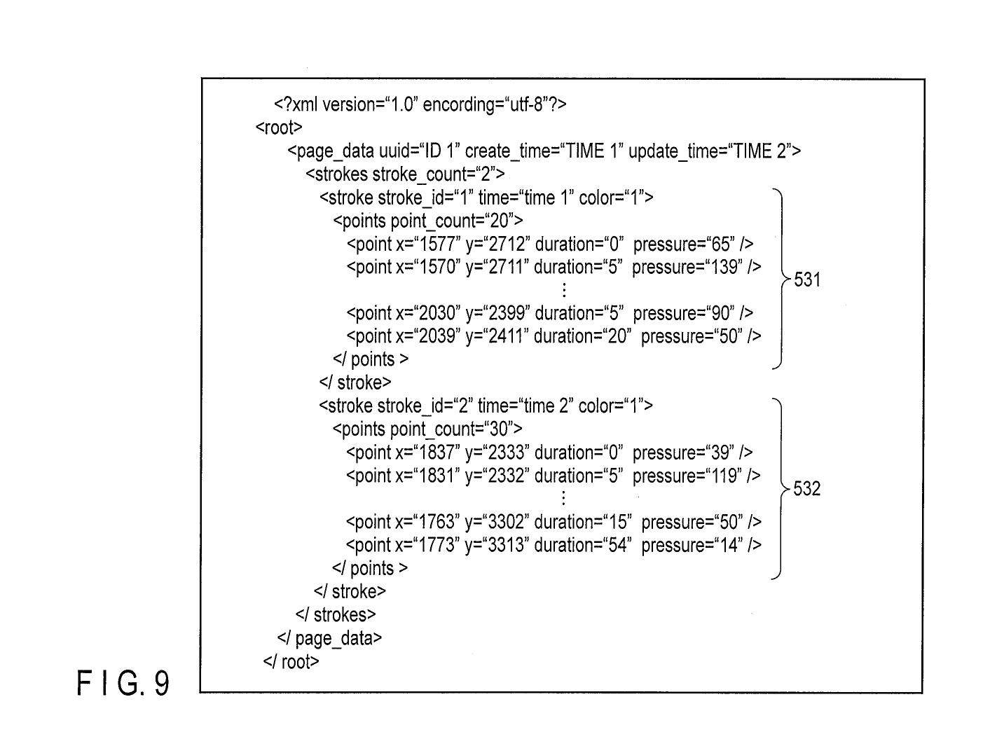

FIG. 9 shows an example of a document structure of an XML file to manage a plurality of strokes in a handwritten page.

The XML file shown in FIG. 9 contains attributes such as a page ID of a handwritten page contained in the XML file, time information of a creation date/time of the handwritten page, and time information of an update date/time of the handwritten page. In addition, the XML file may contain attributes such as “width” showing the width of the handwritten page, “height” showing the height of the handwritten page, and “title” showing the title of the handwritten page.

The XML file shown in FIG. 9 contains stroke data 531, 532 of two strokes. For example, a “stroke_count” attribute shows the number (total number) of pieces of stroke data contained currently in the XML file. Each time stroke data is newly stored in the XML file, the attribute value of the “stroke_count” attribute is updated. FIG. 9 illustrates a case when the attribute value of the “stroke_count” attribute is “2”.

A “stroke” element contains, for example, a “stroke_id” attribute, a “time” attribute, and a “color” attribute. The “stroke_id” attribute shows identification information (stroke ID) of the corresponding stroke data. The “time” attribute is time information of the time when the corresponding data is written by hand. The “time” attribute may be the absolute time (year, month, day, hour, minute, second) when the corresponding data is written by hand. The “color” attribute shows the color of a trajectory corresponding to the corresponding stroke data. Further, the “stroke” element may contain a “width” attribute showing the width (line width) of a trajectory corresponding to the stroke data, a “type” attribute showing the line type (for example, a solid line, broken line and the like) of a trajectory corresponding to the stroke data and the like.

A “points” element contains, for example, a “point_count” attribute. The “point_count” attribute shows the total number of “point” elements contained in the “points” element, that is, the total number of pieces of coordinate data.

A plurality of “point” elements grouped by the “points” element corresponds to a plurality of pieces of coordinate data in a stroke. One “point” element corresponds to one piece of coordinate data.

The “point” element contains, for example, an “x” attribute, a “y” attribute, a “duration” attribute, and a “pressure” attribute. The “x” attribute shows the x coordinate of the corresponding coordinate data. The “y” attribute shows the y coordinate of the corresponding coordinate data. The “duration” attribute is time information of the time interval from the handwriting start time of the corresponding stroke data until the corresponding coordinate data is written by hand. The “pressure” attribute shows the writing pressure when the coordinate data is input.

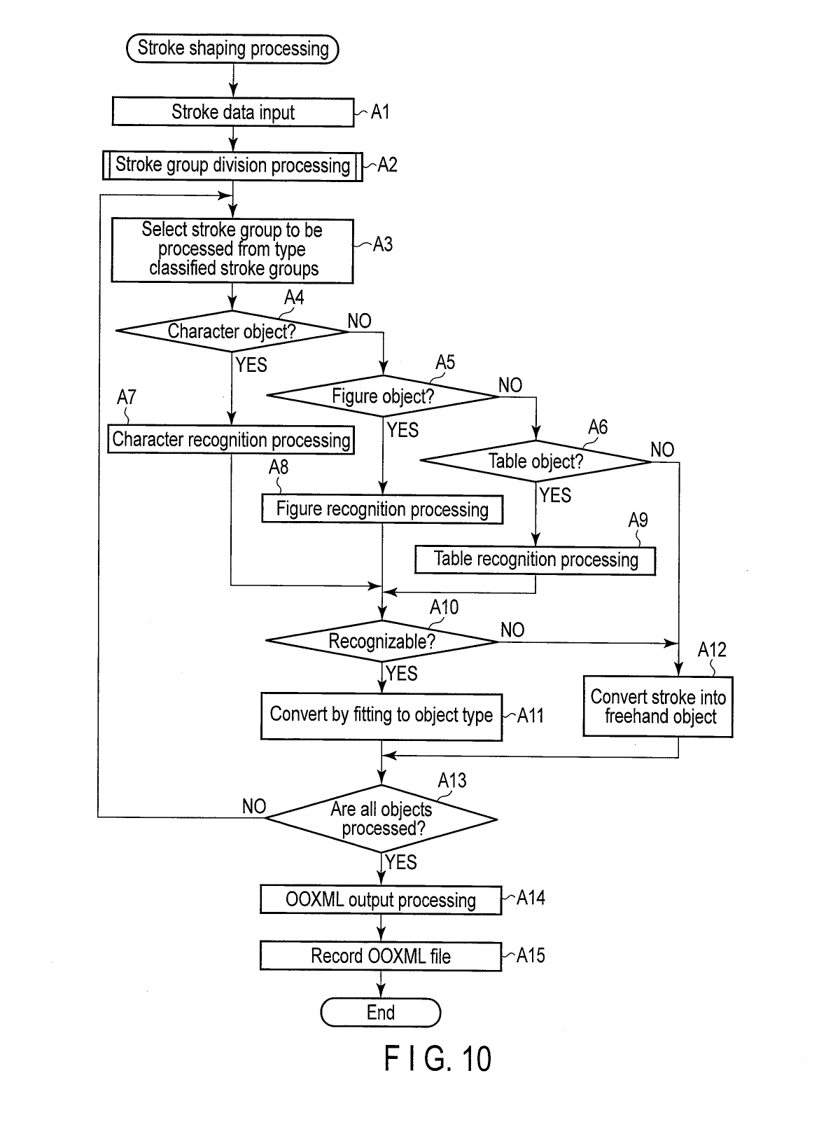

Next, the operation of the tablet computer 10 will be described with reference to the flow chart shown in FIG. 10.

It is assumed here that, as shown in FIG. 6, the user has input by handwriting a plurality of strokes on the note view screen using the pen 100. Stroke data of the plurality of strokes input by handwriting is recorded in the handwritten note recording module 411 as an XML file. It is also assumed that a tap operation of the shaping button among a plurality of button icons displayed on the note view screen is performed to instruct the execution of stroke shaping processing.

The stroke division module 313 inputs stroke data recorded in the handwritten note recording module 411 through the stroke management module 312 (step A1) and performs stroke group division processing (step A2).

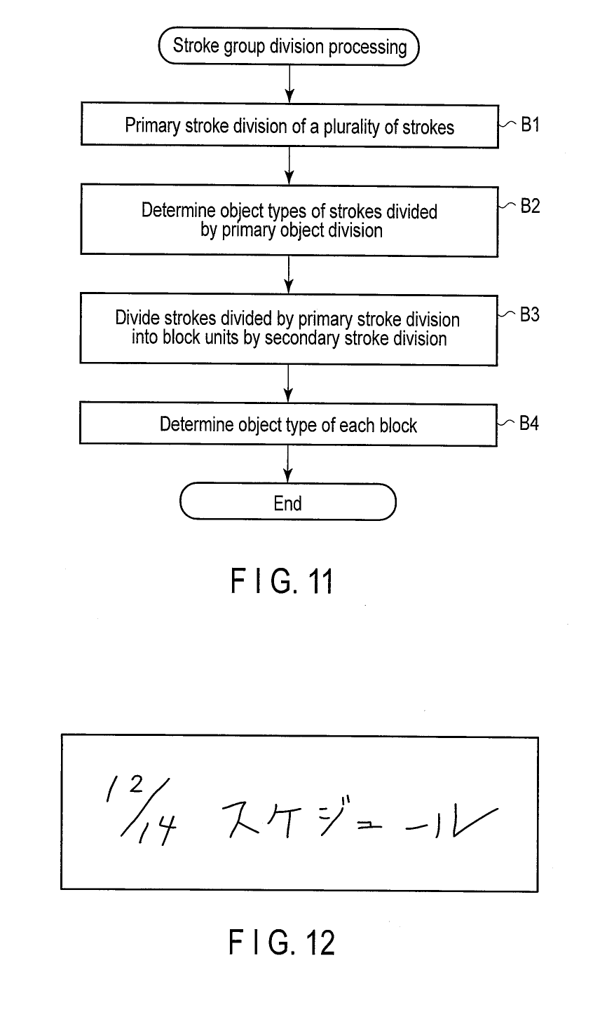

FIG. 11 is a flow chart showing an example of stroke group division processing. FIGS. 12, 13, and 14 are diagrams showing an example of a plurality of strokes to describe a concrete example of the stroke group division processing. The plurality of strokes shown in FIG. 12 contains strokes representing characters and figures.

First, the stroke division module 313 performs primary stroke division of the plurality of strokes as a target for process (step B1). In the primary stroke division, the stroke division module 313 divides the plurality of strokes into stroke groups (blocks) containing at least one stroke based on, for example, the arrangement relation of the strokes indicated by stroke data. Also, the stroke division module 313 divides the plurality of strokes into stroke groups based on, for example, intervals between respective strokes of the plurality of strokes or connecting relations of strokes. Then, the stroke division module 313 determines the type of object of stroke groups (blocks) divided by the primary stroke division (step B2).

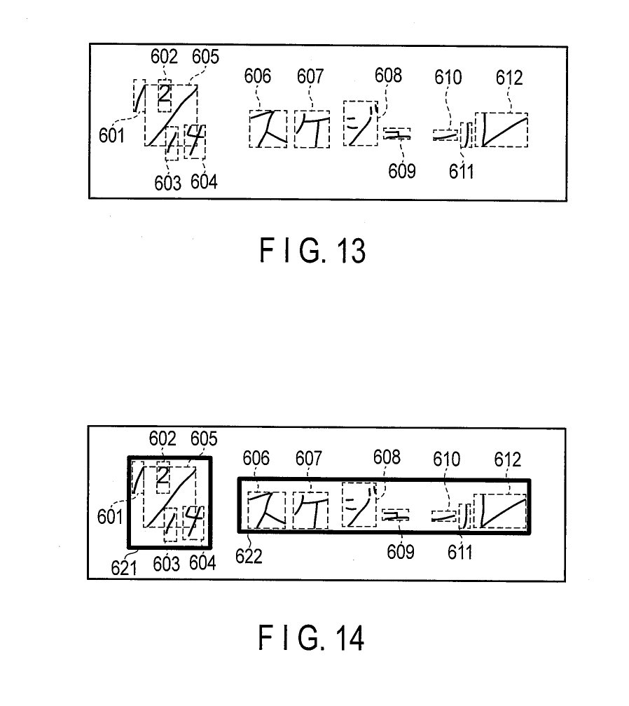

FIG. 13 shows an example of dividing the plurality of strokes shown in FIG. 12 into a plurality of stroke groups by the primary stroke division. FIG. 13 shows an example in which, for example, stroke groups (blocks) 605, 610, 611 are divided as stroke groups corresponding to a figure and other stroke groups 601 to 604, 606 to 609, 612 are divided as stroke groups corresponding to a character.

Next, the stroke division module 313 divides strokes divided by the primary stroke division into units of block by secondary stroke division (step B3). Then, the stroke division module 313 determines the type of object of each block divided by the secondary stroke division (step B4).

FIG. 14 shows an example of dividing the plurality of stroke groups shown in FIG. 13 into a plurality of blocks by the secondary stroke division. FIG. 14 shows an example of dividing the stroke groups into a block 621 including the stroke groups 601 to 605 and the stroke groups 606 into a block 622 including the stroke groups 606 to 612 based on the arrangement relation of the stroke groups.

In the block 621, for example, since the stroke 605 is arranged in a position different from the sequence of the stroke groups 601, 602 and the sequence of the stroke groups 603, 604 divided as character objects and has a size which is different from a size of the stroke groups 601 to 604, the stroke 605 classified as a figure object.

In the block 622, the stroke groups 606 to 612 are arranged in the same sequence (horizontal direction) within a fixed width and thus, the stroke groups (blocks) 610, 611 are determined to be character objects like stroke groups before or after the stroke groups.

In the stroke group division processing, as described above, a plurality of strokes can be divided into stroke groups by object type based on not only the determined object type of stroke groups divided by the primary stroke division, but also the arrangement relation and object type of other surrounding stroke groups. The stroke division module 313 records stroke groups determined to correspond to one of objects (the character, drawing, and table) by the stroke group division processing in the stroke data recording module 412A as the first stroke group.

The stroke division module 313 records stroke groups determined to correspond to none of the objects in the stroke data recording module 412A as the second stroke group.

In the stroke group division processing, strokes can be divided by using not only the arrangement relation of strokes, but also the time (time stamp information) when each stroke is input. For example, when strokes are input by handwriting, a plurality of strokes representing one object like a character, figure, or table is frequently input in a short time and strokes of other objects are frequently input after a long times passes. Thus, if the time before the next stroke is input is equal to a defined time or longer, a stroke of a different object is determined to be input to allow the division of stroke groups. Incidentally, the arrangement relation of strokes and the times when strokes are input may be combined to determine a stroke group for each object.

Next, the shaping processor 314 selects a stroke group as a target for process from stroke groups recorded in the stroke data recording module 412A and whose object type is classified (step A3) and performs recognition processing according to the object type thereof.

For stroke groups of character objects (step A4, Yes), the character recognition module 315A recognizes the stroke groups as characters and converts handwritten characters represented by the stroke groups into respective character code (text data) (step A7). In the character recognition processing, the character having the highest similarity to a prepared dictionary for character recognition is selected as a recognition result of the stroke group and if the similarity does not exceed a defined value, the stroke group is determined to be unrecognizable.

For stroke groups of figure objects (step A5, Yes), the figure recognition module 315B performs figure recognition processing to convert each stroke group into one of a plurality of preset figure objects (such as the circle, square, arrow and the like) (step A8). In the figure recognition processing, the figure object having the highest similarity to a prepared figure objects for recognition is selected as a recognition result of the stroke group and if the similarity does not exceed a defined value, the stroke group is determined to be unrecognizable. For example, as many as a preset number (for example, 34 types) of figure objects for recognition are prepared and if the similarity to none of the preset figure objects exceeds the defined value, the stroke group is determined to be unrecognizable.

For stroke groups of table objects (step A6, Yes), the table recognition module 315C decides the numbers of rows and columns and the size of each cell defining the shape of the table of each stroke group based on a combination of linear strokes in the vertical and horizontal directions (step A9).

If a stroke group is determined to be unrecognizable by the recognition module 315 (step A10, No), the stroke group as a target for process is changed to the second stroke group and recorded in the stroke data recording module 412A.

The shaping processor 314 converts a second stroke recorded in the stroke data recording module 412A into a freehand object. The freehand object is an object representing an undefined stroke and is defined by, like stroke data, freehand object data containing a coordinate data sequence. That is, the freehand object is defined by data representing the same shape as a stroke input by handwriting.

The second stroke group contains stroke groups determined to correspond to none of objects in the stroke group division processing by the stroke division module 313 and stroke groups that are not recognized as one of such objects in the recognition processing by the recognition module 315.

On the other hand, when a stroke group as a target for process is recognized as one of the objects, the shaping module 316 decides data defining the size and display position when the object is displayed on the screen so that the object can be displayed instead of the stroke input by handwriting (step A11). That is, an object such as a character, figure, or table is generated by shaping the stroke input by handwriting.

For example, the character shaping module 316A enlarges or reduces the character font and decides the display position so that the character font corresponding to the character code obtained by character recognition processing is displayed in a size comparable to that of the original stroke group input by handwriting in approximately the same position as the stroke group on the screen (page). If the arrangement of a character string in the page is in an oblique direction, characters may be displayed after being rotated according to the arrangement direction. The display position and size of a stroke group can be determined by, for example, the position and size of a circumscribed rectangular frame after detecting the circumscribed rectangular frame with respect to the stroke group.

The figure recognition module 315B decides the size and display position of a figure object recognized by the figure recognition module 315B in the same manner as the character shaping module 316A.

The table recognition module 315C decides the size and display position of a table object recognized by the table recognition module 315C in the same manner as the character shaping module 316A.

If the processing is not completed for all stroke groups as a target for process recorded in the stroke data recording module 412A (step A13, No), the shaping processor 314 repeatedly performs shaping processing on stroke groups as a target for process in the same manner as described above (steps A3 to A12).

When shaping processing for all stroke groups is completed (step A13, No), the object management module 317 performs OOXML output processing on object data shaped by the shaping module 316 and representing objects such as characters, figures, and tables and freehand object data representing freehand objects (step A14). That is, the object management module 317 converts object data and freehand object data into a data format following a file format of an OOXML file.

The object management module 317 records an OOXML file containing data converted from object data and freehand object data in the object data recording module 412B (step A15).

An OOXML file has a data format that can be processed by other applications, for example, the integrated application program 203. That is, processing on objects like characters, figures, and tables can be performed by the integrated application program 203. Further, the handwritten note application program 202 classifies handwritten input stroke groups (second stroke groups) that can be recognized as none of objects like characters, figures, and tables as freehand objects and records such freehand objects together with object data of other objects in the OOXML file. Therefore, the integrated application program 203 can process freehand objects having the same shape as objects input by handwriting on the tablet computer 10.

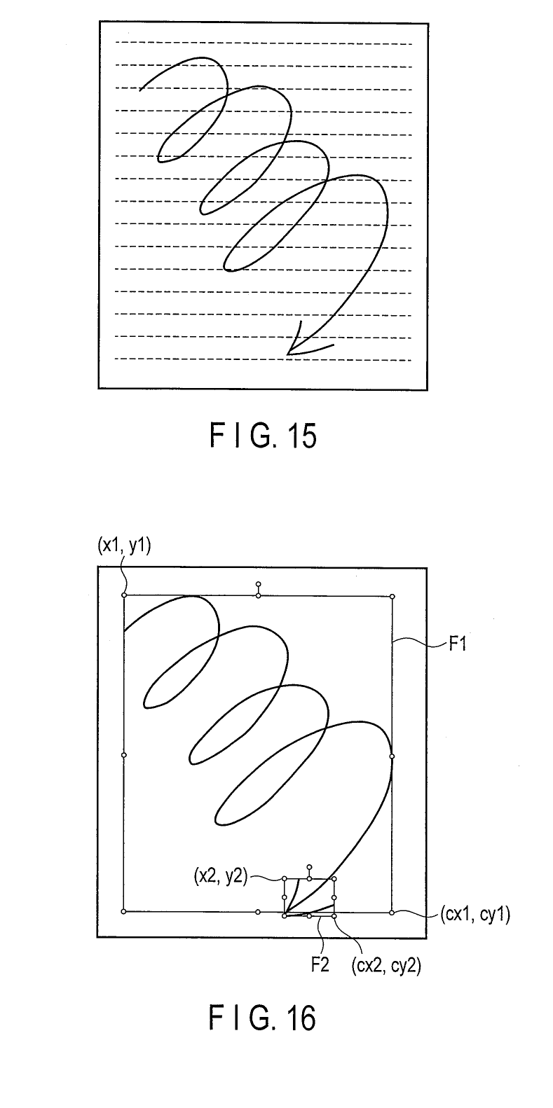

FIG. 15 shows an example of strokes input by handwriting on the note view screen and classified as freehand objects.

The stroke shown in FIG. 15 contains a first stroke in which a curve continues and a second stroke representing a tip portion of an arrow. The two strokes shown in FIG. 15 are classified into the second stroke group by the stroke group division processing or recognition processing and recorded in an OOXML file as freehand objects.

FIG. 16 is a diagram showing an example of the freehand objects into which the two strokes shown in FIG. 15 are converted. A freehand object is defined by, as shown in FIG. 16, a coordinate data sequence representing the shape of a stroke and coordinate data (for example, coordinate data of two diagonal points of a rectangle) showing the circumscribed rectangle of the stroke.

In FIG. 16, a circumscribed rectangle F1 defined by 2-point coordinate data (x1, y1), (cx1, cy1) is set to the freehand object corresponding to the first stroke and a circumscribed rectangle F2 defined by 2-point coordinate data (x2, y2), (cx2, cy2) is set to the freehand object corresponding to the second stroke.

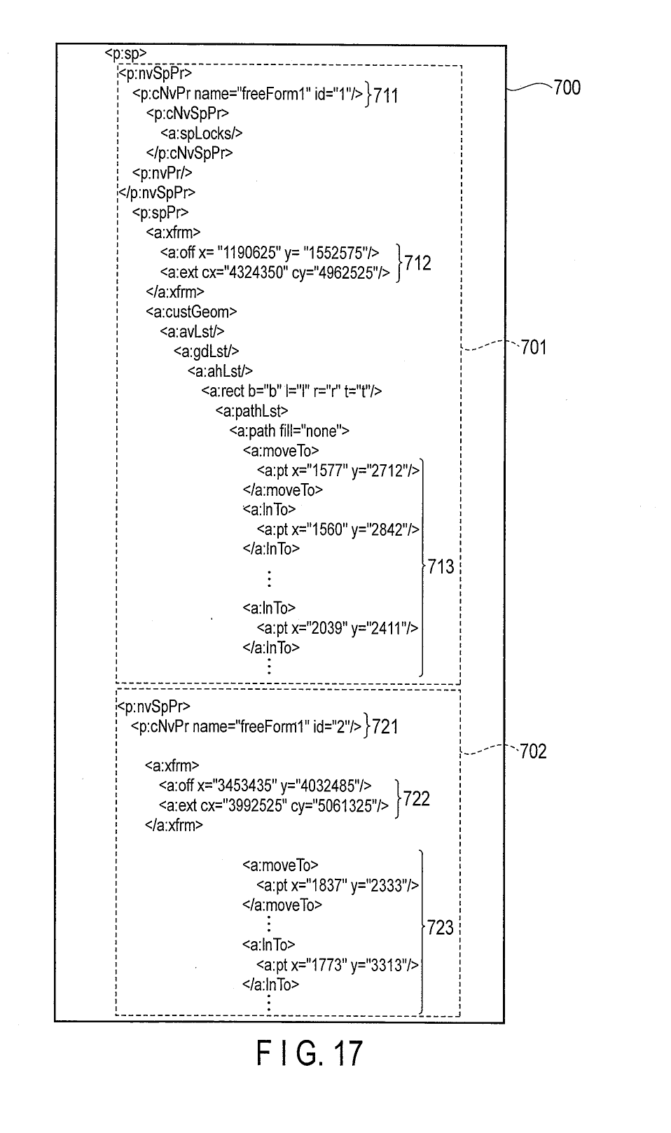

FIG. 17 shows an example of the document structure of an OOXML file containing two strokes set as freehand objects.

The OOXML file shown in FIG. 17 contains data 701 of the freehand object corresponding to the first stroke and data 702 of the freehand object corresponding to the second stroke.

The data 701 contains data 711 (name=“freeForm1” id=“1”) showing that the object type is a freehand object. In this case, the first freehand object is indicated by id=“1”. Also, coordinate data 712 defining the circumscribed rectangle F1 for the first freehand object is contained.

Further, a coordinate data sequence 713 representing the shape of the stroke is contained in the data 701. The coordinate data sequence 713 is data obtained by converting stroke data (coordinate data sequence) of a stroke input by handwriting on the tablet computer 10. A longer stroke has more pieces of coordinate data. Incidentally, there is no need to use all stroke data as coordinate data of the freehand object and coordinate data may be thinned out from stroke data when necessary to use the thinned stroke data as coordinate data of the freehand object.

Similarly, the data 702 contains data 721 (name=“freeForm1” id=“2”) showing that the object type is a freehand object. In this case, the second freehand object is indicated by id=“2”. Also, coordinate data 722 defining the circumscribed rectangle F2 for the second freehand object is contained. Further, a coordinate data sequence 723 representing the shape of the stroke is contained in the data 702.

In the OOXML file, in addition to the coordinate data sequences 713, 723 representing the shapes of the freehand objects (strokes), attribute information of the freehand objects may be defined. The attribute information may contain information showing, for example, the color, line width, and line type (for example, the solid line, broken line and the like) of a stroke.

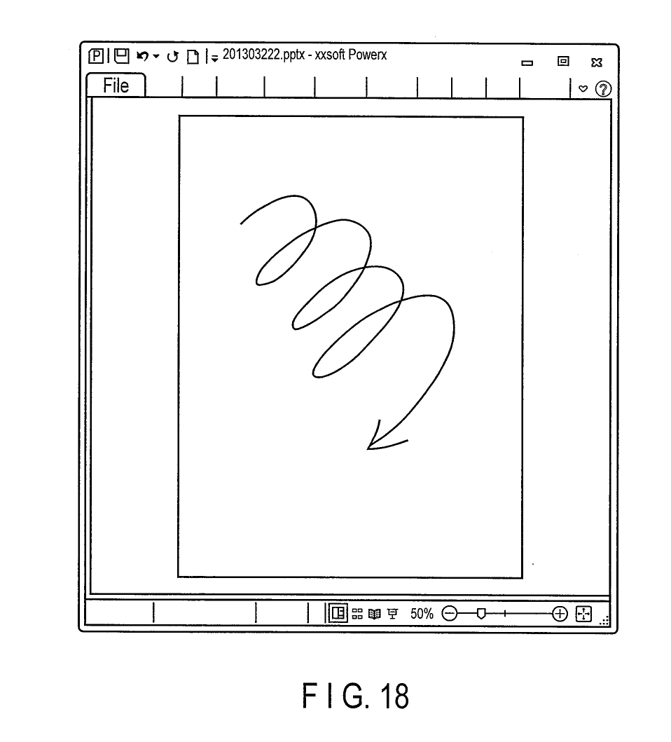

FIG. 18 is a diagram showing a display example of strokes by the integrated application program 203 (presentation processing program 203D). FIG. 18 shows an example of strokes displayed according to description content of the OOXML file shown in FIG. 17 after the OOXML file being read.

Thus, the presentation processing program 203D can display freehand objects in the same shape as strokes input by handwriting on the table computer 10. If editing processing of freehand objects displayed on the screen is instructed, as shown in FIG. 16, the presentation processing program 203D displays circumscribed rectangles to which control points are set together with strokes. Control points are provided to, for example, vertices of the rectangular frame or middle points of lines constituting the rectangular frame. The presentation processing program 203D deforms the circumscribed rectangle according to an input operation to move the position of control points and also deforms the shape of the stroke according to the deformation of the circumscribed rectangle.

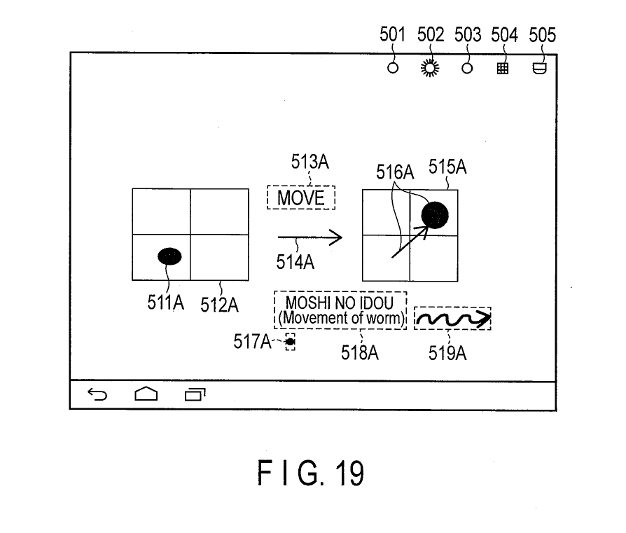

FIG. 19 is a diagram showing a display example obtained by shaping a stroke input by handwriting on the note view screen shown in FIG. 6.

While FIG. 18 shows a display example by the presentation processing program 203D, when a tap operation on the shaping button is performed on the note view screen, as shown in FIG. 19, a plurality of strokes input by handwriting is together shaped into forms according to respective object types.

For example, a plurality of strokes 512, 515 shown in FIG. 6 is shaped, as shown in FIG. 19, into table objects 512A, 515A of a 2×2 matrix. A plurality of strokes 511, 514, 516 representing figures is shaped, as shown in FIG. 19, into figure objects 511A, 514A, 516A according to respective figure types. Also, a plurality of strokes 513, 518 representing characters is shaped, as shown in FIG. 19, into a character object 513A of the alphabet and a character object 518A for Japanese respectively.

Since the stroke 519 shown in FIG. 6 and representing a figure does not correspond to any preset figure object, the stroke 519 is converted into a freehand object 519A, as shown in FIG. 19. As shown in FIG. 19, the freehand object 519A is displayed in the same shape as the stroke input by handwriting. That is, since a stroke that matches none of objects is not forced to be shaped into some object, it is not shaped into an object unintended by the user. Even if a stroke matches none of objects, the stroke remains as a freehand object together with other objects and thus, no data loss is caused.

Like other objects such as characters, figures, and tables, the freehand object 519A is data that can be edited by other applications. Therefore, after shaping processing is performed, the shape or the like of the freehand object 519A can easily be changed without inputting the stroke by handwriting again.

Even if, as shown in FIG. 6, strokes corresponding to a plurality of types of objects are mixed, the handwritten note application program 202 in an embodiment can collectively shape a plurality of strokes, as shown in FIG. 19, into respective corresponding objects. Therefore, when strokes input by handwriting are shaped, the convenience of the user can be improved by reducing user's work loads.

Various kinds of processing performed by the handwritten note application program 202 may be performed by the personal computer 1 or the server 2 on the Internet operating by being linked to the tablet computer 10.

Various kinds of processing on a handwritten document according to the present embodiment can be realized by a computer program and thus, the same effect as that in the present embodiment can easily be realized only by installing the computer program through a computer readable storage medium storing the computer program on an ordinary computer including a touch screen display and executing the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The processing described in the above embodiment can be provided to various apparatuses as a program a computer can be caused to execute by writing the program into a recording medium such as a magnetic disk (a flexible disk, hard disk and the like), an optical disk (CD-ROM, DVD and the like), a semiconductor memory and the like. The program can also be provided to various apparatuses by transmitting the program via a communication medium. The computer reads the program recorded in the recording medium or receives the program via the communication medium and performs the above processing by the operation thereof being controlled by the program.

What is claimed is:

1. An electronic device comprising:
a display processor configured to display strokes handwritten on a screen; and
a processor configured to divide strokes into a first stroke group corresponding to pre-defined objects and a second stroke group that does not correspond to pre-defined objects, wherein
the display processor is configured to display at least one object corresponding to the first stroke group and at least one line corresponding to the second stroke group on the screen after displaying the first stroke group and the second stroke group.

2. The electronic device of claim 1, wherein when the display processor is configured to display the at least one object corresponding to the first stroke group and the at least one line corresponding to the second stroke group on the screen after displaying the first stroke group and the second stroke group, a position where the at least one object is displayed is decided according to a display position of the first stroke group.

3. The electronic device of claim 1, wherein the processor is configured to convert first stroke data representing each of strokes in the first stroke group into first data representing the at least one object in a predetermined data format and to convert second stroke data representing each of strokes in the second stroke group into second data in the data format.

4. The electronic device of claim 3, wherein
the data format can be processed by a single application;
the at least one object comprises first objects which are among pre-defined objects by the application and other than second objects capable of representing a line of any shape; and
the second data comprises third objects which are among the pre-defined objects by the application and capable of representing a line of any shape.

5. The electronic device of claim 1, wherein the display processor is configured to convert the first stroke group into one of a character, a figure, and a table which are in the at least one object.

6. The electronic device of claim 1, wherein the processor is configured to divide the strokes into the first stroke group and the second stroke group based on an arrangement relation of the strokes.

7. The electronic device of claim 1, wherein the display processor is configured to display the at least one object corresponding to the first stroke group after displaying the first stroke group when a similarity between the first stroke group and the at least one object is equal to a reference value or more and to change the first stroke group to the second stroke group when the similarity is smaller than the reference value.

8. A method comprising:
displaying strokes handwritten on a screen;
dividing the strokes into a first stroke group corresponding to pre-defined objects and a second stroke group that does not correspond to pre-defined objects, wherein
the displaying comprises displaying at least one object corresponding to the first stroke group and at least one line corresponding to the second stroke group on the screen after displaying the first stroke group and the second stroke group.

9. The method of claim 8, wherein when the at least one object corresponding to the first stroke group and the at least one line corresponding to the second stroke group on the screen are displayed after displaying the first stroke group and the second stroke group, a position where the at least one object is displayed is decided according to a display position of the first stroke group.

10. The method of claim 8, wherein the dividing comprises converting first stroke data representing each of strokes in the first stroke group into first data representing the at least one object in a predetermined data format and converting second stroke data representing each of strokes in the second stroke group into second data in the data format.

11. The method of claim 10, wherein
the data format can be processed by a single application;
the at least one object comprises first objects which are among pre-defined objects by the application and other than second objects capable of representing a line of any shape; and
the second data comprises third objects which are among the pre-defined objects by the application and capable of representing a line of any shape.

12. The method of claim 8, wherein the displaying comprises converting the first stroke group into one of a character, a figure, and a table which are in the at least one object.

13. The method of claim 8, wherein the dividing comprises dividing the strokes into the first stroke group and the second stroke group based on an arrangement relation of the strokes.

14. The method of claim 8, wherein the displaying comprises displaying the at least one object corresponding to the first stroke group after displaying the first stroke group when a similarity between the first stroke group and the at least one object is equal to a reference value or more and changing the first stroke group to the second stroke group when the similarity is smaller than the reference value.

15. A computer-readable, non-transitory storage medium having stored thereon a computer program which is executable by a computer, the computer program controlling the computer to execute functions of:
displaying strokes handwritten on a screen; and
dividing the strokes into a first stroke group corresponding to pre-defined objects and a second stroke group that does not correspond to pre-defined objects, wherein
the displaying comprises displaying at least one object corresponding to the first stroke group and at least one line corresponding to the second stroke group on the screen after displaying the first stroke group and the second stroke group.

16. The storage medium of claim 15, wherein when the at least one object corresponding to the first stroke group and the at least one line corresponding to the second stroke group on the screen are displayed after displaying the first stroke group and the second stroke group, a position where the at least one object is displayed is decided according to a display position of the first stroke group.

17. The storage medium of claim 15, wherein the dividing comprises converting first stroke data representing each of strokes in the first stroke group into first data representing the at least one object in a predetermined data format and converting second stroke data representing each of strokes in the second stroke group into second data in the data format.

18. The storage medium of claim 17, wherein
the data format can be processed by a single application;
the at least one object comprises first objects which are among pre-defined objects by the application and other than second objects capable of representing a line of any shape; and
the second data comprises third objects which are among the pre-defined objects by the application and capable of representing a line of any shape.

19. The storage medium of claim 15, wherein the displaying comprises converting the first stroke group into one of a character, a figure, and a table which are in the at least one object.

20. The storage medium of claim 15, wherein the dividing comprises dividing the strokes into the first stroke group and the second stroke group based on an arrangement relation of the strokes.

21. The storage medium of claim 15, wherein the displaying comprises displaying the at least one object corresponding to the first stroke group after displaying the first stroke group when a similarity between the first stroke group and the at least one object is equal to a reference value or more and changing the first stroke group to the second stroke group when the similarity is smaller than the reference value.
